(19) United States
(12) Patent Application Publication
(10) Pub. No.: US 2016/0075236 A1
(43) Pub. Date: Mar. 17, 2016

(54) SURGE PROTECTION DEVICE FOR PROTECTING AN ONBOARD POWER SYSTEM OF AN ELECTRIC VEHICLE FROM AN ELECTRIC SURGE, CORRESPONDING METHOD, AND ELECTRIC VEHICLE WITH THE SURGE PROTECTION DEVICE

(71) Applicant: Robert Bosch GmbH, Stuttgart (DE)

(72) Inventors: Stephan Gase, Tiefenbronn (DE); Thomas Peuser, Ludwigsburg (DE)

(21) Appl. No.: 14/785,890

(22) PCT Filed: Mar. 27, 2014
(86) PCT No.: PCT/EP2014/056184

§ 371 Date: Oct. 21, 2015

(30) Foreign Application Priority Data
Apr. 25, 2013 (DE) 10 2013 207 514.6

(51) Int. Cl. B60L 3/00; H02H 9/00; H02H 9/04; B60L 11/18

(52) U.S. Cl. CPC B60L 3/0046; B60L 11/1825; H02H 9/005; H02H 9/04

(57) ABSTRACT

The invention relates to a surge protection device (100) for protecting an onboard power system (24) of an electric vehicle (20) from an electric surge, having the following: an input device (105) which is designed as a current terminal of the electric vehicle (20); a protection device (110) which has at least one surge arrester (111) for arresting a surge; and an interface device (115) which is designed to protect the onboard power system (24) of the electric vehicle (20) from the electric surge by coupling an outlet (110b) of the protection device (110) to the onboard power system (24).

### BACKGROUND OF THE INVENTION

The present invention relates to a surge protection device for protecting an onboard power system of an electric vehicle from an electric surge, a corresponding method and an electric vehicle with the surge protection device.

A socket outlet comprising a module for additional functions is previously known from the European patent publication EP 0 786 833 B1. The additional functions relate primarily to achieving a surge protection for loads that are connected to the socket outlet.

The European patent publication EP 0 786 833 B1 describes a module in which the height of the insulant base does not have to be changed. The configuration of an available outlet free space and the configuration of the components of the module to be placed therein are matched to each other with respect to their shape. In the module described in said publication, a printed circuit board is provided which extends parallel to the bottom of the existing insulant base and has at least two corners which accommodate surge protection components.

The printed circuit board is in turn equipped for the electrical connection to resilient contacts, wherein the socket outlets have blade contacts which produce the necessary electrical connection when inserting and connecting the components.

A socket outlet, in particular a safety socket outlet with a retrofittable surge protection is previously known from the German utility model DE 295 07 448 U1. The local surge protection is designed as a load-bearing part comprising moldings for a printed circuit board, wherein the circuit board accommodates necessary electrical components. The load-bearing part has openings, through which electrical connection lines for the surge protection device run, in a bottom section of the safety socket outlet described there.

The German patent publication DE 20 2008 008 905 U1 describes a surge protection device also for the subsequent insertion into connecting boxes, junction boxes and/or socket outlets for surface-mounted or flush-mounted installation, wherein the socket outlets have a mounting plate, also referred to as a support ring.

The aforementioned surge protection device has a circuit board for accommodating the surge protection elements and a load-bearing part comprising moldings for the circuit board and electrical connecting means, wherein the load-bearing part has an annular integral extension which engages around the socket outlet insert in the installed state.

### SUMMARY OF THE INVENTION

The present invention relates to a surge protection device for protecting an onboard power system of an electric vehicle from an electric surge.

A surge protection device is correspondingly provided, comprising: an input device which is designed as a current terminal of the electric vehicle, a protection device which has at least one surge arrester for arresting a surge; and an interface device which is designed to protect the onboard power system of the electric vehicle from the electric surge by coupling an outlet of the protection device to the onboard power system.

The invention furthermore relates to a method for protecting an onboard power system of an electric vehicle from an electric surge.

A method comprising the following steps is correspondingly provided: coupling of an input device of a surge protection device of the electric vehicle to a charging device and coupling a protection device of the surge protection device to the input device; providing a surge arrester in the protection device for arresting a surge; coupling an outlet of the protection device to the onboard power system via an interface device in order to protect the onboard power system of the electric vehicle from the electric surge.

In addition, the present invention relates to an electric vehicle comprising a surge protection device.

The concept of the invention is based on the fact that a lightening protection and surge protection means is configured in an electric vehicle at a location which is downstream of a charging socket of the electric vehicle.

This advantageously prevents electrical components in the onboard power system of the electric vehicle from being destroyed by surge pulses when charging the vehicle battery. The surge protection device can be provided at a central location downstream of the charging socket in the electric vehicle.

By means of a central surge protection which is downstream of the charging socket in the electric vehicle, the electrical high-voltage components of the onboard power system of the electric vehicle can be designed according to a respectively optimal surge class for air gaps and creepage distances.

As a result, installation space and costs can be saved for the onboard power system of the electric vehicle because the electrical high-voltage components of the electric vehicle and/or the onboard power system itself do not in each case require their own surge protection systems.

Provision is made according to one embodiment of the invention for the input device to be designed to be coupled to a charging device. This allows for the electric vehicle to be charged with electrical energy supplied by the charging device in a simple and safe manner.

Provision is made according to one embodiment of the invention for the at least one surge arrester to be designed to arrest a surge of up to 1.5 kV or of up to 3 kV or of up to 6 kV or of up to 10 kV. As a result, a surge protection can be advantageously provided for the onboard power system of the electric vehicle.

Provision is made according to one embodiment of the invention for the protection device to be formed integrally with the input device. As a result, a common carrier element can be used for the protection device and the input device and the design of the surge protection device can be simplified.

Provision is made according to one embodiment of the invention for the protection device to be coupled to the input device at an inlet thereof. This advantageously allows for a modular design of the surge protection device, whereby the individual components of the surge protection device can be replaced in a target-oriented manner if necessary.

Provision is made according to one embodiment of the invention for the at least one surge arrester to be designed in such a way that, when an electric surge occurs, a voltage of less than 1.5 kV is applied to the outlet of the protection device as a result of the electric surge being arrested.

Provision is made according to one embodiment of the invention for the surge arrester to be designed as a gas-filled surge arrester or as a gas discharge tube. As a result, a gas discharge can ignite when a component-specific ignition voltage has been exceeded in the gas discharge tube, and the terminal voltage at the surge arrester is reduced by means of an arc discharge.

Provision is made according to one embodiment of the invention for the surge arrester to be designed as a varistor. This advantageously allows for the surge arrester to absorb large amounts of energy within a short response time of under one nanosecond or of under one microsecond without being destroyed.

Provision is made according to one embodiment of the invention for the surge arrester to be designed as a suppressor diode. As a result, a surge arrestor can advantageously be provided which does not cause a voltage drop in the voltage to be protected and therefore is further ready for use without any power interruption after being triggered.

Provision is made according to one embodiment of the invention for the interface device to be designed to be coupled to at least one electrical load or to a plurality of electrical loads of the electric vehicle and to protect the at least one coupled electrical load or the coupled electrical loads from the electric surge. By means of one central surge protection unit downstream of the charging socket in the electric vehicle, all of the electrical components which are downstream of the surge protection unit can be dimensioned according to the simplest protection requirements.

The embodiments and modifications described can be arbitrarily combined with each other.

Further possible embodiments, modifications and implementations of the invention also do not explicitly comprise specified combinations of features of the present invention which were previously described or will be described below with regard to the exemplary embodiments.

### BRIEF DESCRIPTION OF THE DRAWINGS

The attached drawings are meant to convey a further understanding of the embodiments of the invention. Said drawings illustrate embodiments and are used in conjunction with the detailed description of principles and concepts of the invention.

Other embodiments and many of the stated advantages ensue in view of the drawings. The elements of the drawings depicted are not necessarily shown true to scale in relation to one another.

In the drawings:

FIG. 1 shows a schematic depiction of a surge protection device for protecting an onboard power supply of an electric vehicle from an electric surge according to one embodiment of the invention;

FIG. 2 shows a schematic depiction of an electric vehicle comprising a surge protection device for protecting an onboard power system of an electric vehicle from an electric surge according to a further embodiment of the invention; and

FIG. 3 shows a schematic depiction of a flow diagram of a method for protecting an onboard power supply of an electric vehicle from an electric surge according to yet another embodiment of the invention.

### DETAILED DESCRIPTION

In the figures of the drawings, identical reference signs denote identical or functionally identical elements, parts, components or procedural steps so far as nothing is stated to the contrary.

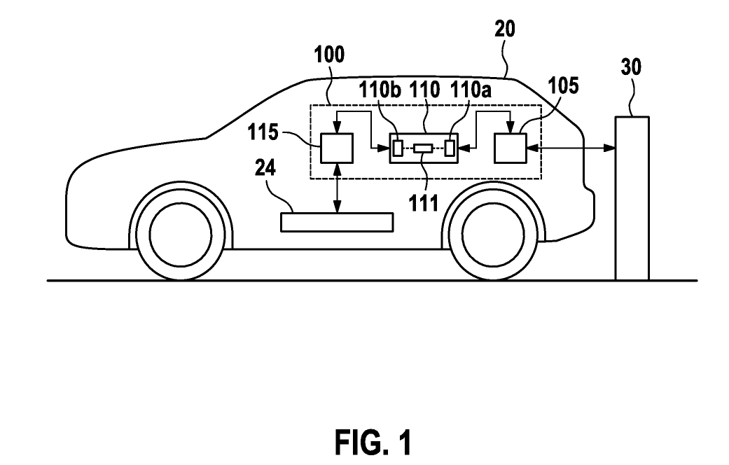

FIG. 1 shows a schematic depiction of a surge protection device for protecting an onboard power system of an electric vehicle from an electric surge according to one embodiment of the invention.

A surge protection device 100 for protecting an onboard power system 24 of an electric vehicle 20 from an electric surge comprises an input device 105, a protection device 110 and an interface device 115.

Electric signals can be interference signals which occur in an energy grid or a power supply system of a charging device 30, such as lightning strikes, surge pulses or other disturbances as they occur by means of the breakdown of connection couplings.

The input device 105 of the surge protection device 100 can be designed as a current terminal of the electric vehicle 20. The input device 105 can be designed as a charging socket or as a charging outlet for receiving a plug connector for charging the electric vehicle 20.

The protection device 110 of the surge protection device 100 can be coupled to the input device 105 at an inlet 110a of said protection device 110 and have at least one surge arrester 111 for arresting the electric surge.

In derogation from the embodiment of the surge protection device depicted in FIG. 1, the protection device 110 can also be integrally designed with the input device 105, wherein the term “integrally designed” means that a design of the protection device 110 and the input device 105 in a common housing is provided.

In terms of circuitry, the protection device 110 can also be integrated with the input device, and a common printed circuit board or some other common carrier element for electronic components can be designed for the protection device 110 and the input device 105.

The protection device 110 and the input device 105 of the surge protection device 100 can likewise be configured in a single integrated circuit.

The interface device 115 of the surge protection device 100 is, for example, designed by means of a coupling of an outlet 110b of the protection device 110 to the onboard power system 24 to protect said onboard power system 24 of the electric vehicle 20 from the electric surge.

The interface device 115 of the surge protection device 100 can, for example, be designed as a distributor unit which comprises a plurality of components, such as, for example, indicator lights, programmable logic controllers and other automation components and supply outlets.

The input device 105 of the surge protection device 100 can furthermore be designed to be coupled to a charging device 30.

The surge protection device 100 thereby provides a central protection function for all of the electronic components which are coupled to the onboard power system 24 of the electric vehicle 20 by means of collectively securing all of the electronic components with the aid of the upstream protection device 110.

By means of a central protection unit downstream of the input device 105, all of the electrical components of the onboard power supply 24 of the electric vehicle 20 downstream of said central protection unit can be dimensioned having the simplest protection requirements.

The at least one surge arrester 111 of the protection device 110 can furthermore be designed to arrest a surge of up to 1.5 kV or of up to 3 kV or of up to 6 kV. A surge can be arrested via a ground connection of the electric vehicle 20 or via a ground connection of the charging device 30.

As a result of arresting the electric surge when said electric surge occurs, a voltage of less than 1.5 kV is, for example, applied to the outlet 110b of the protection device 110. In so doing, simple safety means can be used in the electrical onboard power supply for the surge protection of the individual electrical components.

The surge arrester 111 of the protection device 110 can, for example, be designed as a gas-filled surge arrester 111 or as a gas suppressor or as a varistor or as a suppressor diode.

Components for protecting the inputs and outputs of electronic circuits from momentary surge pulses or voltage transients, as they occur from switching operations in the power grid or in the proximity of lightning strikes, are used as a suppressor diode, i.e. transient absorption Zener diode, in abbreviated form TAZ diode, or as a transient voltage suppressor diode, in abbreviated form TVS diode.

A gas discharge tube, which is used to protect from surge pulses, can, for example, be used as a gas suppressor. The surge is degraded in the gas discharge tube by means of a self-activating ignition of a gas discharge.

The interface device 115 of the surge protection device 100 can be designed to be coupled to at least one electrical load or to a plurality of electrical loads of the electrical onboard power system 24 of the electric vehicle and to protect the at least one coupled electrical load or the coupled electrical loads of the electrical onboard power system 24 of the electric vehicle 20 from electric surges.

The electric vehicle 20 to be protected can be designed as an electric vehicle, a hybrid motor vehicle or as another kind of motor vehicle which has an electrical energy store that can be charged by a charging device 30 designed as a stationary charging station or as a charging pole during a charging process.

The charging device 30 is, for example, a device or an electrical installation, which is or are used to recharge battery operated electric vehicles 20 by simply inserting a standard plug into a corresponding socket. The stationary charging device 30 can be designed as a part of a charging station.

The stationary charging device 30 comprises, for example, a plug connector or a plug which is adapted to a socket outlet or a socket of the electric vehicle.

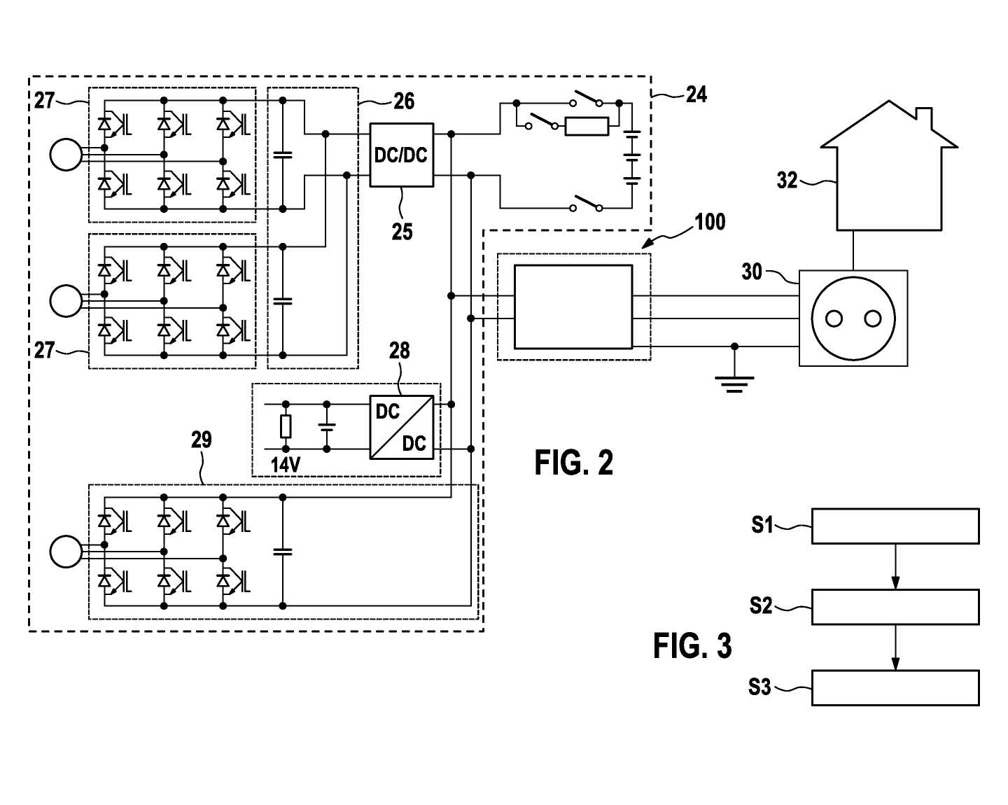

FIG. 2 shows a schematic depiction of an electric vehicle comprising a surge protection device for protecting an onboard power system of an electric vehicle from an electric surge according to a further embodiment of the invention.

An electric vehicle 20 comprises, for example, a surge protection device 100 for protecting an onboard power supply system 24 of an electric vehicle 20. The electric vehicle 20 can be charged with a charging device 30 designed as a stationary charging pole.

The charging pole can have a socket outlet which is part of a household power supply 32. The household power supply 32 can have lightning protection means, which allow electric surges of up to 6 kV. An external lightning protection can, for example, be connected to the potential equalization of the building.

The upstream surge protection device 100 can be designed such that the at least one surge arrester 111 of the surge protection device 100 is configured in such a way that a voltage of less than 1.5 kV is applied to the outlet 110b of the protection device 110 as a result of arresting the electric surge when said surge occurs in the system.

As a result, the electric components of the electric vehicle 20 are all protected from a maximum surge of maximally 1.5 kV.

The electric onboard power system 24 of the electric vehicle 20 can, for example, comprise a DC converter 25, an intermediate circuit 26, electric drive systems 27, a 14 volt onboard power system 28 with an integrated DC converter and an electric air processor circuit 29 as electric components.

The additional reference signs shown in FIG. 2 have already been explained in the description of the drawings associated with FIG. 1 and will therefore not be further described.

FIG. 3 shows a schematic depiction of a flow diagram of a method for protecting an onboard power system of an electric vehicle from an electric surge according to a further embodiment of the invention.

As a first procedural step of the method for protecting an onboard power system of an electric vehicle, an input device 105 of a surge protection device 100 of the electric vehicle 20 is coupled to a charging device 30; and a protection device 110 of the surge protection device 100 is coupled via an inlet 110a of the protection device 110 to the input device 105.

As a second procedural step of the method for protecting an onboard power system of an electric vehicle, a surge arrester 111 is provided S2 in the protection device 110 for arresting a surge.

As a third procedural step of the method for protecting an onboard power system of an electric vehicle, the output 110b of the protection device 110 is coupled S3 to the onboard power system 24 via an interface device 115 in order to protect said onboard power system 24 of the electric vehicle 20 from the electric surge.

The procedural steps can thereby be repeated in any order, iteratively or recursively.

Although the present invention was described above with the aid of preferred exemplary embodiments, it is not limited thereto but can be modified in many ways. The invention can particularly be modified in a variety of ways without departing from the gist of the invention.

1. A surge protection device for protecting an onboard power system of an electric vehicle from an electric surge, the surge protection device comprising:
an input device configured as a current terminal;
a protection device which has at least one surge arrester for arresting a surge; and
an interface device configured to protect the onboard power system of the electric vehicle from an electric surge by coupling an outlet of the protection device to the onboard power system.

2. The surge protection device according to claim 1,
wherein
the input device is configured to be coupled to a charging device.

3. The surge protection device according to claim 2,
wherein
the at least one surge arrester is configured for arresting a surge of up to 1.5 kV or of up to 3 kV or of up to 6 kV.

4. The surge protection device according to claim 1,
wherein
the protection device is integral with the input device.

5. The surge protection device (100) according to claim 1,
wherein
the protection device is coupled to the input device at an inlet of said protection device.

6. The surge protection device according to claim 1,
wherein
the at least one surge arrester is configured so that a voltage of less than 1.5 kV is applied to the outlet of the protection device as a result of the electric surge being arrested when said electric surge occurs.

7. The surge protection device according to claim 1,
wherein
the surge arrester comprises a gas-filled surge arrester or as a gas discharge tube.

8. The surge protection device according to claim 1,
wherein
the surge arrester is configured as a varistor.

9. The surge protection device according to claim 1,
wherein
the surge arrester is configured as a suppressor diode.

10. The surge protection device (100) according to claim 1,
wherein
the interface device is designed to be coupled to at least one electric load or to a plurality of electric loads of the electric vehicle and to protect the at least one coupled electric load or the coupled electric loads from the electric surge.

11. A method for protecting an onboard power system of an electric vehicle from an electric surge, the method comprising:
coupling an input device of a surge protection device of the electric vehicle to a charging device and coupling a protection device of the surge protection device to the input device;
providing a surge arrester in the protection device for arresting a surge; and
coupling the outlet of the protection device to the onboard power system via an interface device in order to protect said onboard power system of the electric vehicle from the electric surge.

12. An electric vehicle comprising a surge protection device for protecting an onboard power system of an electric vehicle from an electric surge, the surge protection device including
an input device configured as a current terminal;
a protection device having at least one surge arrester for arresting a surge; and
an interface device configured to protect the onboard power system of the electric vehicle from an electric surge by coupling an outlet of the protection device to the onboard power system.
